(19) United States
(12) Patent Application Publication
(10) Pub. No.: US 2025/0340726 A1
(43) Pub. Date: Nov. 6, 2025

(54) PROPYLENE-BASED COPOLYMER COMPOSITION

(71) Applicant: Basell Poliolefine Italia S.r.l., Milano (IT)

(72) Inventors: Alberta De Capua, Ferrara (IT); Eleonora Ciaccia, Ferrara (IT); Claudio Cavalieri, Ferrara (IT); Alessia Di Capua, Ferrara (IT); Lelio Basile, Ferrara (IT); Tiziana Caputo, Ferrara (IT)

(73) Assignee: Basell Poliolefine Italia S.r.l., Milano (IT)

(21) Appl. No.: 18/854,156

(22) PCT Filed: Apr. 7, 2023
(86) PCT No.: PCT/EP2023/059308

§ 371 Date: Oct. 4, 2024

(30) Foreign Application Priority Data
Apr. 12, 2022 (EP) 22167919.4

(51) Int. Cl. C08L 23/14; B65D 1/02

(52) U.S. Cl. CPC C08L 23/142; B65D 1/0207; C08L 2203/10; C08L 2205/025

(57) ABSTRACT

A polyolefin composition made from or containing:
A) from 70 wt % to 90 wt % of a copolymer of propylene with ethylene, having:
a content of ethylene derived units, measured by NMR, between 3.3 wt % and 6.0 wt %; and
B) from 10 wt % to 30 wt % of a propylene ethylene copolymer,
containing from 3.5 wt % to 7.5 wt % of ethylene derived units, measured by NMR, and
having a melt flow rate (230° C./2.16 kg. ISO 1133) ranging from 0.6 g/10 min to 10 g/10 min;
wherein the polyolefin composition has:
a content of ethylene derived units, measured by NMR, between 3.5 wt % and 5.5 wt %;
a xylene solubles fraction at 25° C. ranging from 5.1 wt % to 12.0 wt %; and
the difference between the ethylene derived units content of component (B) and the ethylene derived units content of component (A) (C2B−C2A) ranging from 0.3 to 5.0 wt %;
the sum A+B being 100.

### FIELD OF THE INVENTION

In general, the present disclosure relates to the field of chemistry. More specifically, the present disclosure relates to polymer chemistry. In particular, the present disclosure relates to a composition made from or containing propylene ethylene copolymers and blow-molded articles made therefrom.

### BACKGROUND OF THE INVENTION

In some instances, different applications use tailored polymers, thereby achieving the individual demanding properties. For instance, a polymer used for injection molding has other properties as a polymer used for blow molding.

In some instances, the extrusion blow molding process allow for the preparation of different kinds of bottles with respect to size and shape. In some instances, the solidification step of the extrusion blow molding process is more complex than in an injection molding process.

In some instances, extrusion blown molded articles show poorer optical properties compared to injection molded articles. In some instances, the surface property inside or outside of extrusion blown bottles is non-uniform (having flow lines or melt fracture), thereby leading to lower overall gloss and transparency as compared to injection-molded bottles or injection-stretched, blow-molded, bottles.

During an extrusion blow molding (EBM) process, a polymer melt is first extruded through a tubular die into air, thereby forming a polymer tube. In some instances, the polymer tube is referred to as “parison,” Next, the polymer tube is blown up until the outside of the tube reaches the boundaries of the mold. In some instances, covering the wall of the mold fully with the blown-up polymer tube is difficult as compared to injection molding. It is believed that the challenges arise from removing the air between the polymer tube and mold. Further, the inside of the polymer tube is not in contact with the mold, providing little possibility to influence the inner surface structure of the tube.

### SUMMARY OF THE INVENTION

In a general embodiment, the present disclosure provides a polyolefin composition made from or containing:
A) from 70 wt % to 90 wt % of a copolymer of propylene with ethylene, having:
   i) a content of ethylene derived units, measured by NMR, between 3.3 wt % and 6.0 wt %, based upon the total weight of the copolymer (A);
   ii) a melting temperature, measured by DSC, ranging from 132° C. to 143° C.;
   iii) a melt flow rate (230° C./2.16 kg. ISO 1133) ranging from 1.1 g/10 min to 3.5 g/10 min; and
   iv) xylene solubles at 25° C. ranging from 4.0 wt % to 10.0 wt %, based upon the total weight of the copolymer (A); and
B) from 10 wt % to 30 wt % of a propylene ethylene copolymer,
   i) containing from 3.5 wt % to 7.5 wt % of ethylene derived units, measured by NMR, based upon the total weight of the propylene ethylene copolymer (B); and
   ii) having a melt flow rate (230° C./2.16 kg. ISO 1133) ranging from 0.6 g/10 min to 10 g/10 min;
wherein the polyolefin composition has:
   i) a content of ethylene derived units, measured by NMR, between 3.5 wt % and 5.5 wt %, based upon the total weight of the polyolefin composition;
   ii) a xylene solubles fraction at 25° C. ranging from 5.1 wt % to 12.0 wt %, based upon the total weight of the polyolefin composition;
   iii) a content of ethylene derived units, measured by NMR, in the fraction soluble in xylene at 25° between 15.2 wt % and 23.2 wt %, based upon the weight of the xylene solubles fraction;
   iv) a melt flow rate (ISO 1133 (230° C., 2.16 kg) ranging from 1.0 g/10 min to 4.0 g/10 min;
   v) an intrinsic viscosity, measured in tetrahydronaphthalene at 135° C., of the fraction soluble in xylene at 25° C., ranging from 0.6 dl/g to 2.5 dl/g; and
   vi) the difference between the ethylene derived units content of component (B) and the ethylene derived units content of component (A) (that is, C2B−C2A) ranging from 0.3 to 5.0 wt %;
the sum A+B being 100.

### DETAILED DESCRIPTION OF THE INVENTION

In some embodiments, the present disclosure provides a polyolefin composition made from or containing:
A) from 70 wt % to 90 wt %; alternatively from 72 wt % to 88 wt %; alternatively from 73 wt % to 86 wt %, of a copolymer of propylene with ethylene, having:
i) a content of ethylene derived units, measured by NMR, between 3.3 wt % and 6.0 wt %; alternatively between 3.5 wt % and 5.5 wt % alternatively between 3.7 wt % and 4.8 wt %, based upon the total weight of the copolymer (A);
ii) a melting temperature, measured by DSC, ranging from 132° C. to 143° C.; alternatively from 134° C. to 142° C.; alternatively from 136° C. to 141° C.;
iii) a melt flow rate (230° C./2.16 kg. ISO 1133) ranging from 1.1 g/10 min to 3.5 g/10 min;
alternatively from 1.2 g/10 min to 2.5 g/10 min; alternatively from 1.3 g/10 min to 2.0 g/10 min; and
iv) xylene solubles at 25° C. ranging from 4.0 wt % to 10.0 wt %; alternatively from 4.5 wt % to 9.0 wt %; alternatively from 5.2 wt % to 8.0 wt %, based upon the total weight of the copolymer (A);
B) from 10 wt % to 30 wt %; alternatively from 12 wt % to 30 wt %; alternatively from 13 wt % to 28 wt %; alternatively from 14 wt % to 27 wt %, of a propylene ethylene copolymer,
i) containing from 3.5 wt % to 7.5 wt %, alternatively 3.6 wt % to 7.5 wt %; alternatively from 3.8 wt % to 7.0 wt %; alternatively from 4.0 wt % to 6.8 wt %, of ethylene derived units, measured by NMR, based upon the total weight of the propylene ethylene copolymer (B); and
ii) having a melt flow rate (230° C./2.16 kg. ISO 1133) ranging from 0.6 g/10 min to 10 g/10 min; alternatively from 0.8 g/10 min to 9 g/10 min; alternatively from 2.0 g/10 min to 8.5 g/10 min;
wherein the polyolefin composition has:
i) a content of ethylene derived units, measured by NMR, between 3.5 wt % and 5.5 wt %; alternatively between 3.8 wt % and 5.3 wt %; alternatively between 3.9 wt % and 5.0 wt %, based upon the total weight of the polyolefin composition;
ii) a xylene solubles fraction at 25° C. ranging from 5.1 wt % to 12.0 wt %; alternatively from 5.5 wt % to 11.0 wt %; alternatively from 6.0 wt % to 10.0 wt %, based upon the total weight of the polyolefin composition;
iii) a content of ethylene derived units, measured by NMR, in the fraction soluble in xylene at 25° between 15.2 wt % and 23.2 wt %; alternatively between 16.3 wt % and 22.2 wt %; alternatively between 17.2 wt % and 21.3 wt %, based upon the weight of the xylene solubles fraction;
iv) a melt flow rate (ISO 1133 (230° C., 2.16 kg) ranging from 1.0 g/10 min to 4.0 g/10 min;
alternatively from 1.1 g/10 min to 2.9 g/10 min; alternatively from 1.2 g/10 min to 2.5 g/10 min;
v) an intrinsic viscosity, measured in tetrahydronaphthalene at 135° C., of the fraction soluble in xylene at 25° C., ranging from 0.6 dl/g to 2.5 dl/g; alternatively from 0.8 dl/g to 2.0 dl/g; alternatively from 1.0 dl/g to 1.8 dl/g;
vi) the difference between the ethylene derived units content of component (B) and the ethylene derived units content of component (A) (that is, C2B−C2A) ranges from 0.3 to 5.0 wt %; alternatively from 0.4 to 4.0 wt %; alternatively from 0.4 and 3.0 wt %;
the sum A+B being 100.

As used herein, the term “copolymer” refers to a bipolymer containing two monomers, propylene and ethylene.

In some embodiments, the polyolefin composition has one or more of the following features:
i) a haze, measured on 1 mm plaque, ranging from 20.0% to 26.0 alternatively from 21.0% to 25.0%; alternatively from 22.0% to 24.5%;
ii) a Flexural modulus (ASTM D 790) ranging from 500 MPa to 770 MPa; alternatively from 550 MPa to 740 MPa; alternatively from 600 MPa to 720 MPa;
iii) a Charpy impact strength at 23° C. (ISO 179-1:2010) ranging from 8.0 kj/m² to 20.0 kj/m²; alternatively from 10.0 kj/m² to 18.0 kj/m²; alternatively from 10.5 kj/m² to 17.0 kj/m²; or
iv) a ratio between flexural modulus and haze (F/H ratio) ranging from 25.0 to 31.0; alternatively from 25.5 to 30.0; alternatively from 26.0 to 29.0. It is believed that a higher ratio indicates that the flexural modulus is too high, thereby not providing a composition that is soft enough. It is also believed that a lower ratio indicates that the haze is too high, thereby providing a material with poor optical properties.

In some embodiments, the polyolefin composition is useful for obtaining small blow molded articles such as bottles.

In some embodiments, the present disclosure provides a bottle made from or containing the polyolefin composition.

In some embodiments, the polyolefin composition is prepared by blending components A) and B).

In some embodiments, the polymerization of A) and B) is carried out in the presence of Ziegler-Natta catalysts. The catalysts are made from or containing a solid catalyst component made from or containing a titanium compound having a titanium-halogen bond and an electron-donor compound. The titanium compound and the electron-donor compound are supported on a magnesium halide in active form. The Ziegler-Natta catalysts are used with an organoaluminium compound as a cocatalyst. In some embodiments, the organoaluminum compound is an aluminum alkyl compound.

An external donor is optionally added.

In some embodiments, the catalysts yield a polypropylene with a value of xylene insolubility at ambient temperature greater than 90%, alternatively greater than 95%.

In some embodiments, the catalysts are as described in U.S. Pat. No. 4,399,054 and European Patent No. 45977. In some embodiments, the catalysts are as described in U.S. Pat. No. 4,472,524.

In some embodiments, the solid catalyst components, used as electron-donors (internal donors), are selected from the group consisting of ethers, ketones, lactones, compounds containing N, P and/or S atoms, and esters of mono- and dicarboxylic acids.

In some embodiments, the electron-donor compounds are esters of phthalic acid and 1,3-diethers of formula:

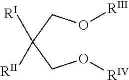

wherein R^{I} and R^{II} are the same or different and are C₁-C₁₈ alkyl, C₃-C₁₈ cycloalkyl, or C₇-C₁₈ aryl radicals; R^{III} and R^{IV} are the same or different and are C₁-C₄ alkyl radicals; or are the 1,3-diethers wherein the carbon atom in position 2 belongs to a cyclic or polycyclic structure made up of 5, 6, or 7 carbon atoms, or of 5-n or 6-n′ carbon atoms, and respectively n nitrogen atoms and n′ heteroatoms selected from the group consisting of N, O, S and Si, where n is 1 or 2 and n′ is 1, 2, or 3, the structure containing two or three unsaturations (cyclopolyenic structure), and optionally being condensed with other cyclic structures, or substituted with one or more substituents selected from the group consisting of linear or branched alkyl radicals; cycloalkyl, aryl, aralkyl, alkaryl radicals, and halogens, or being condensed with other cyclic structures and substituted with one or more of the above-mentioned substituents; one or more of the above-mentioned alkyl, cycloalkyl, aryl, aralkyl, or alkaryl radicals and the condensed cyclic structures optionally containing one or more heteroatom(s) as substitutes for carbon or hydrogen atoms, or both. In some embodiments, the substituents are bonded to the condensed cyclic structures.

In some embodiments, the ethers are selected from the ethers described in European Patent Application Nos. 361493 and 728769.

In some embodiments, the diethers are selected from the group consisting of 2-methyl-2-isopropyl-1,3-dimethoxypropane, 2,2-diisobutyl-1,3-dimethoxypropane, 2-isopropyl-2-cyclopentyl-1,3-dimethoxypropane, 2-isopropyl-2-isoamyl-1,3-dimethoxypropane, and 9,9-bis(methoxymethyl) fluorene.

In some embodiments, the electron-donor compounds are phthalic acid esters. In some embodiments, the phthalic acid esters are selected from the group consisting of diisobutyl phthalate, dioctyl phthalate, diphenyl phthalate, and benzylbutyl phthalate.

In some embodiments, a MgCl2·nROH adduct is reacted with an excess of TiCl4 containing the electron-donor compound. In some embodiments, the adduct is in the form of spheroidal particles. In some embodiments, n is from 1 to 3. In some embodiments, ROH is selected from the group consisting of ethanol, butanol, and isobutanol. In some embodiments, the reaction temperature is from 80 to 120° C. The solid is then isolated and reacted once more with TiCl4, in the presence or absence of the electron-donor compound, after which the reaction product is separated and washed with aliquots of a hydrocarbon until the chlorine ions have disappeared.

In some embodiments and in the solid catalyst component, the titanium compound, expressed as Ti, is present in an amount from 0.5 to 10% by weight. In some embodiments, the quantity of electron-donor compound which remains fixed on the solid catalyst component is 5 to 20% by moles with respect to the magnesium dihalide.

In some embodiments, the titanium compounds used for the preparation of the solid catalyst component are selected from the group consisting of halides of titanium and halogen alcoholates of titanium. In some embodiments, the titanium compound is titanium tetrachloride.

In some embodiments, the reactions form magnesium halide in active form. In some embodiments, magnesium halide in active form results from reaction starting with magnesium compounds other than halides, such as magnesium carboxylates.

In some embodiments, the Al-alkyl compounds used as co-catalysts are made from or containing Al-trialkyls. In some embodiments, the Al-trialkyls are selected from the group consisting of Al-triethyl, Al-triisobutyl, Al-tri-n-butyl, and linear or cyclic Al-alkyl compounds containing two or more Al atoms bonded to each other by way of O or N atoms, or SO4 or SO3 groups.

In some embodiments, the Al-alkyl compound is used in such a quantity that the Al/Ti ratio is from 1 to 1000.

In some embodiments, the electron-donor compounds used as external donors are selected from the group consisting of aromatic acid esters and silicon compounds. In some embodiments, the aromatic acid esters are alkyl benzoates. In some embodiments, the silicon compounds contain at least one Si—OR bond, where R is a hydrocarbon radical.

In some embodiments, the silicon compounds are selected from the group consisting of (tert-butyl)2Si(OCH3)2, (cyclohexyl)(methyl)Si (OCH3)2, (cyclopentyl)2Si(OCH3)2, (phenyl)2Si(OCH3)2, and (1,1,2-trimethylpropyl)Si(OCH3)3.

In some embodiments, the internal donor is a 1,3-diether and the external donors are omitted.

In some embodiments, the component A) is prepared by using catalysts containing a phthalate, as internal donor, and (cyclopentyl)2Si(OCH3)2, as outside donor. In some embodiments, the component A) is prepared by using catalysts containing 1,3-diethers as internal donors.

In some embodiments, the Ziegler-Natta catalyst is a solid catalyst component made from or containing a magnesium halide, a titanium compound having at least a Ti-halogen bond, and at least two electron donor compounds selected from succinates and the other being selected from 1,3 diethers.

In some embodiments, component B) is prepared by using the catalyst system or by using metallocene based catalyst system. In some embodiments, component B) is obtained by using gas phase polymerization processes, slurry polymerization processes, or solution polymerization processes.

In some embodiments, components (A) and (B) are prepared in a continuous sequential polymerization process, wherein component A) is prepared in a first reactor and component (B) is prepared in a second reactor in the presence of component A), operating in gas phase, in liquid phase in the presence or not of inert diluent, or by mixed liquid-gas techniques.

The following examples are given for illustration without limiting purpose.

### EXAMPLE

### Characterization Methods

Melting temperature and crystallization temperature: Determined by differential scanning calorimetry (DSC)

A sample, weighing 6±1 mg, was heated to 220±1° C. at a rate of 20° C./min and kept at 220±1° C. for 2 minutes in nitrogen stream. Thereafter, the sample was cooled at a rate of 20° C./min to 40±2° C. The sample was maintained at this temperature for 2 min, thereby permitting the sample to crystallize. Then, the sample was again fused at a temperature rise rate of 20° C./min up to 220° C.±1. The melting scan was recorded. A thermogram was obtained. The melting temperatures and crystallization temperatures were read.

Melt Flow Rate: Determined according to the method ISO 1133 (230° C., 2.16 kg).

### Xylene-Soluble Fraction (XS) at 25° C.

Xylene Solubles at 25° C. were determined according to ISO 16152:2005; with solution volume of 250 ml, precipitation at 25° C. for 20 minutes, including 10 minutes with the solution in agitation (magnetic stirrer), and drying at 70° C.

### Intrinsic Viscosity (I.V.)

The sample was dissolved in tetrahydronaphthalene at 135° C. and then poured into the capillary viscometer.

The viscometer tube (Ubbelohde type) was surrounded by a cylindrical glass jacket, which permitted temperature control with a circulating thermostatic liquid.

The downward passage of the meniscus was timed by a photoelectric device. The passage of the meniscus in front of the upper lamp started the counter, which had a quartz crystal oscillator. The counter stopped as the meniscus passed the lower lamp. The efflux time wad registered and converted into a value of intrinsic viscosity.

### Haze (on 1 mm Plaque)

5×5 cm specimens were cut molded plaques of 1 mm thick. The haze value was measured using a Gardner photometric unit connected to a Hazemeter type UX-10 or an equivalent instrument having G.E. 1209 light source with filter “C”. Standard samples were used to calibrate the instrument. The plaques were produced according to the following method.

75×75×1 mm plaques were molded with a GBF Plastiniector G235190 Injection Molding Machine, 90 tons under the following processing conditions:
Screw rotation speed: 120 rpm
Back pressure: 10 bar
Melt temperature: 260° C.
Injection time: 5 sec
Switch to hold pressure: 50 bar
First stage hold pressure: 30 bar
Second stage pressure: 20 bar
Hold pressure profile: First stage 5 sec
Second stage 10 sec
Cooling time: 20 sec
Mold water temperature: 40° C.

### Ethylene Content in the Copolymers

¹³C NMR spectra were acquired on a Bruker AV-600 spectrometer equipped with cryoprobe, operating at 160.91 MHz in the Fourier transform mode at 120° C.

The peak of the Sββ carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as an internal standard at 29.9 ppm. The samples were dissolved in 1,1,2,2-tetrachloroethane-d2 at 120° C. with an 8% wt/v concentration. Each spectrum was acquired with a 90° pulse, and 15 seconds of delay between pulses and CPD, thereby removing ¹H-¹³C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethyl-aluminum chloride” M. Kakugo, Y. Naito, K. Mizunuma and T. Miyatake, Macromolecules, 1982, 15, 1150) using the following equations:

$$PPP = 100 T ββ / S \qquad PPE = 100 T βδ / S \qquad EPE = 100 T δδ / S$$

$$PEP = 100 S ββ / S \qquad PEE = 100 S βδ / S \qquad EEE = 100 ( 0.25 S γδ + 0.5 S δδ ) / S$$

$$S = T ββ + T βδ + T δδ + S ββ + S βδ + 0.25 S γδ + 0.5 S δδ$$

The molar percentage of ethylene content was evaluated using the following equation:

E % mol=100*[PEP+PEE+EEE]

The weight percentage of ethylene content was evaluated using the following equation:

$$100 * E \% mol * MWE$$

$$E \% wt . = E \% mol * MWE + P \% mol * MWP$$

where P % mol is the molar percentage of propylene content, while MWE and MWP are the molecular weights of ethylene and propylene, respectively.

The product of reactivity ratio r1r2 was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of propylene sequences was calculated as mm content from the ratio of the PPP mm Tββ (28.90-29.65 ppm) and the whole Tββ (29.80-28.37 ppm).

Impact test: ISO 180

Preparation of injection molded specimens: test specimens 80×10×4 mm were obtained according to the method ISO 1873-2:2007.

Charpy Impact test at 23° C.: measured according to ISO 179-1:2010 on injection molded specimens.

### Example 1

### Catalyst System

The Ziegler-Natta catalyst was prepared as described for Example 5, lines 48-55 of European Patent No. EP728769. Triethylaluminium (TEAL) was used as co-catalyst with dicyclopentyldimethoxysilane (DCPMS) as external donor, with the weight ratios indicated in Table 1.

### Prepolymerization Treatment

The solid catalyst component was subjected to prepolymerization by suspending the solid catalyst component in liquid propylene at 20° C. for about 5 minutes before introducing the solid catalyst component into the first polymerization reactor.

### Polymerization

The polymerization run was conducted in continuous mode in a series of three reactors equipped with devices to transfer the product from each reactor to the subsequent reactor. The first two reactors were liquid phase reactors, and the third was a fluidized-bed, gas phase reactor. Component (A) was prepared in the first and second reactors. Component (B) was prepared in the third reactor.

Hydrogen was used as a molecular weight regulator.

The gas phase (propylene, ethylene, and hydrogen) was continuously analyzed via gas-chromatography.

At the end of the run, the powder was discharged and dried under a nitrogen flow.

The main polymerization conditions are reported in Table 1.

TABLE 1

| | | ex1 | ex2 | ex3 |
|---|---|---|---|---|
| TEAL/solid catalyst component | | 9.2 | 8.8 | 9.3 |
| weight ratio | | | | |
| TEAL/DCPMS weight ratio | | 3 | 4 | 4 |
| Liquid phase reactors | | | | |
| Polymerization temperature | ° C. | 67 | 67 | 67 |
| Pressure | Bar-g | 39 | 39 | 39 |
| Residence time | minutes | 51 | 50 | 53 |
| H2 feed | molppm | 401 | 423 | 420 |
| C2/(C2 + C3) | Mol ratio | 0.049 | 0.050 | 0.050 |
| Polymerization temperature | ° C. | 80 | 80 | 80 |
| Pressure | Barg | 18 | 18 | 18 |
| Residence time | min | 49 | 47 | 52 |
| C2/(C2 + C3) | Mol ratio | 0.052 | 0.058 | 0.062 |
| H2/C2 | Mol ratio | 0.083 | 0.087 | 0.082 |

C2 = ethylene;
C3 = propylene;
H2 = hydrogen

Table 2 reports the features of the compositions of examples 1-3 and comparative example 4.

TABLE 2

| Example | | Ex1 | Ex2 | Ex3 | comp Ex4 |
|---|---|---|---|---|---|
| Component A) | | | | | |
| Ethylene content | wt % | 4.0 | 4.3 | 4.3 | 2.6 |
| MFR | g/10′ | 1.5 | 1.5 | 1.6 | 5 |
| Xylene soluble at | wt % | 6.0 | 7.2 | 6.4 | — |
| 25° C. | | | | | |
| Melting temperature | ° C. | 139 | 137.8 | 137.5 | — |
| Component B) | | | | | |
| split | wt % | 18 | 22 | 22 | 59.8 |
| Ethylene content in | wt % | 4.6 | 5.7 | 6.1 | 6.6 |
| component b)* | | | | | |
| MFR* | g/10′ | 2.55 | 2.65 | 7.24 | 0.66 |
| Property of the | | | | | |
| composition | | | | | |
| Xylene soluble at | wt % | 6.8 | 8.3 | 9.0 | — |
| 25° C. | | | | | |
| MFR | g/10′ | 1.56 | 1.71 | 2.23 | 1.9 |
| XSIV (intrinsic | dl/g | 1.1 | 1.23 | 1.25 | 1.8 |
| viscosity of XS) | | | | | |
| Ethylene content on | Wt % | 18.8 | 18.2 | 17.9 | 17.6 |
| the xylene soluble | | | | | |
| fraction | | | | | |
| Ethylene content | wt % | 4.1 | 4.6 | 4.7 | 5.0 |
| Flexural Modulus | MPa | 710 | 660 | 630 | 792 |
| Haze (1 mm plaque) | % | 23.9 | 23.2 | 23.5 | 20.1 |
| Charpy impact | Kj/m² | 11.8 | 12.3 | 10.4 | — |
| strength 23° C. | | | | | |
| ratio FM/H | | 29.7 | 28.4 | 26.8 | 39.4 |

*calculated
Comparative Ex4 was prepared as described for example P2 of Patent Cooperation Treaty Publication No. WO 2020/148319.

What is claimed is:

1. A polyolefin composition comprising:
A) from 70 wt % to 90 wt % of a copolymer of propylene with ethylene, having:
i) a content of ethylene derived units, measured by NMR, between 3.3 wt % and 6.0 wt %, based upon the total weight of the copolymer (A);
ii) a melting temperature, measured by DSC, ranging from 132° C. to 143° C.;
iii) a melt flow rate (230° C./2.16 kg. ISO 1133)-ranging from 1.1 g/10 min to 3.5 g/10 min; and
iv) xylene solubles at 25° C. ranging from 4.0 wt % to 10.0 wt %, based upon the total weight of the copolymer (A); and
B) from 10 wt % to 30 wt %; of a propylene ethylene copolymer,
i) containing from 3.5 wt % to 7.5 wt % of ethylene derived units measured by NMR, based upon the total weight of the propylene ethylene copolymer (B); and
ii) having a melt flow rate (230° C./2.16 kg. ISO 1133) ranging from 0.6 g/10 min to 10 g/10 min;
wherein the polyolefin composition has:
i) a content of ethylene derived units, measured by NMR, between 3.5 wt % and 5.5 wt %, based upon the total weight of the polyolefin composition;
ii) a xylene solubles fraction at 25° C. ranging from 5.1 wt % to 12.0 wt %, based upon the total weight of the polyolefin composition;
iii) a content of ethylene derived units, measured by NMR, in the fraction soluble in xylene at 25° between 15.2 wt % and 23.2 wt %, based upon the weight of the xylene solubles fraction;
iv) a melt flow rate (ISO 1133 (230° C., 2.16 kg), ranging from 1.0 g/10 min to 4.0 g/10 min;
v) an intrinsic viscosity, measured in tetrahydronaphthalene at 135° C., of the fraction soluble in xylene at 25° C., ranging from 0.6 dl/g to 2.5 dl/g; and
vi) the difference between the ethylene derived units content of component (B) and the ethylene derived units content of component (A) (C2B−C2A) ranging from 0.3 to 5.0 wt %;
the sum A+B being 100.

2. The polyolefin composition according to claim 1, wherein component A) has the content of ethylene derived units between 3.5 wt % and 5.5 wt %.

3. The polyolefin composition according to claim 1, wherein component A) has the melt flow rate (230° C./2.16 kg. ISO 1133) ranging from 1.2 g/10 min to 2.5 g/10 min.

4. The polyolefin composition according to claim 1, wherein component A) has the xylene solubles at 25° C. ranging from 4.5 wt % to 9.0 wt %.

5. The polyolefin composition according to claim 1, wherein component B) has the ethylene derived units content ranging from 3.8 wt % to 7.0 wt %.

6. The polyolefin composition according to claim 1, having the content of ethylene derived units, measured by NMR, between 3.8 wt % and 5.3 wt %.

7. The polyolefin composition according to claim 1, having the content of ethylene derived units, measured by NMR, in the fraction soluble in xylene at 25° between 16.3 wt % and 22.2 wt %.

8. The polyolefin composition according to claim 1, having the melt flow rate (ISO 1133 (230° C., 2.16 kg) ranging from 1.1 g/10 min to 2.9 g/10 min.

9. The polyolefin composition according to claim 1, having the xylene solubles at 25° C. ranges from 5.5 wt % to 11.0 wt %.

10. The polyolefin composition according to claim 1, having the intrinsic viscosity, measured in tetrahydronaphthalene at 135° C., of the fraction soluble in xylene at 25° C. ranges from 0.8 dl/g to 2.0 dl/g.

11. The polyolefin composition according to claim 1, having the difference between the ethylene derived units content of component B and the ethylene derived units content of component B (C2B−C2A) ranging from 0.4 to 4.0 wt %.

12. The polyolefin composition according to claim 1, wherein component B) has the melt flow rate (230° C./2.16 kg. ISO 1133) ranging from 0.8 g/10 min to 9.0 g/10 min.

13. The polyolefin composition according to claim 1, having the content of ethylene derived units, measured by NMR, in the fraction soluble in xylene at 25° between 17.2 wt % and 21.3 wt %.

14. A blow molded article comprising the polyolefin composition according to claim 1.

15. The blow molded article according to claim 14, wherein the article is a bottle.
